(19) United States
(12) Patent Application Publication
(10) Pub. No.: US 2018/0275095 A1
(43) Pub. Date: Sep. 27, 2018

(54) Method for testing and analysis of cyclic stability of electrochromic materials using multi-cycle and double potential step chronocoulometry

(71) Applicant: BEIJING UNIVERSITY OF TECHNOLOGY, Beijing (CN)

(72) Inventors: Hui YAN, Beijing (CN); Kailing ZHOU, Beijing (CN); Hao WANG, Beijing (CN); Yongzhe ZHANG, Beijing (CN)

(21) Appl. No.: 15/541,727

(22) PCT Filed: Oct. 19, 2016
(86) PCT No.: PCT/CN2016/102864

§ 371 Date: Jul. 6, 2017

(30) Foreign Application Priority Data
Aug. 4, 2016 (CN) 201610633499.9

(51) Int. Cl. G01N 27/42; G02F 1/15; G02F 1/13

(52) U.S. Cl. CPC G01N 27/42; G02F 1/1309; G02F 1/15

(57) ABSTRACT

A cyclic stability testing method of electrochromic materials based on multi-cycle and double potential step chronocoulometry is described herein. The method belongs to the area of function material testing and analyzing technology. Testing of the electrochromic film may be implemented through multi-cycle and double potential step technology. The extracted charge quantity Qₑₓ and the injected charge quantity Qᵢₙ, reversibility R of the film cyclic can be obtained by Qₑₓ/Qᵢₙ directly. Evaluation requirements of electrochromic materials cyclic performance may be satisfied. This technology divides overall response charges into three parts which are Faraday charge quantity Q_{f}, adsorption charge quantity Q_{ads} and electric double layer charge quantity Q_{dl}. Influencing factors of ion, electron transmission characteristics, and film cyclic stability can be judged by comparing the changing status of Q_{f} and Q_{dl}+nFAΓ under the multi-cyclic condition, which is convenient for researching and modifying of film electrochromic performance and life cycles.

### CROSS REFERENCE TO RELATED APPLICATION

This application is a national stage application of International application number PCT/CN2016/102864, filed Oct. 19, 2016, titled “A method for testing and analysis of cyclic stability of electrochromic materials using multi-cycle and double potential step chronocoulometry,” which claims the priority benefit of Chinese Patent Application No. 201610633499.9, filed on Aug. 4, 2016, which is hereby incorporated by reference in its entirety.

### TECHNICAL FIELD

The present disclosure relates to a testing method of electrochromic materials based on multi-cycle and double potential step chronocoulometry in the area of function material testing and analyzing technology.

### BACKGROUND

With the fast development of industry, energy shortage and environment pollution become a key problem for human society. Developed country uses a large amount of energy for construction temperature adjustment, and energy consumption of air conditioning is the most energy consumption way. Therefore, any measures to reduce energy consumption are important. For example, smart windows that adjust solar spectrum to realize energy conservation and comfortability. Such technology has wider applications in the future. There are a lot of substances that change color once they are heated, lighted or forced by electric fields, which is called color-causing. This kind of material can adjust solar electromagnetic radiation constantly, and reversible under the external force, and color-causing may be divided into phototropy, thermochromism, electrochromism, vapochromic and photoelectrochromic, and research on electrochromic materials are hot areas.

Electrochromism means a condition that materials change colors that are steady and reversible under the electric force. When electrons and ions of the electrochromic material are extracted and injected under electrochemical action, the valence state and chemical compositions are changed which lead to the change of reflection and transmission performance of the material, which is shown a reversible change of colors and transparency. The key characteristics of electrochromic materials are provided below. (1) Charges can be extracted and injected in electrochromic materials easily through changing of external current or voltage, and electrochromic degree is judged by a number of charges extracted or injected. Thus, the electrochromic degree can be controlled by adjusted external voltage and current. (2) Coloring or fading can be realized easily by voltage polarity. (3) Colored materials under outage condition don't participate in a redox reaction, the colored state is maintained and has memory ability. The outstanding performance and application prospect in energy saving of electrochromic film draw public concern and matches developing a tendency of smart materials in the future.

Electrochromic material should have to meet the following requirements: [1] better electrochemical redox reversibility, [2] shorter response time of changing color, [3] higher sensitivity of changing color, [4] longer recycle life, [5] longer memory time of opening circuit, [6] better chemical stability, as compared to other techniques. However, the current electrochromic material has a great distance behind actual demand since the performance of electrochromic film attenuates largely after manifold cycles. Thus, the cycle time is the determining factor for application prospect of electrochromic material. It is well known that researcher uses cyclic voltammetry to observe and compare cycle performance of the electrochromic material, which is an impartment technique for electrochromism. However, there is nearly no mechanism analysis for electrochromic film attenuation due to the limitation of testing technology. As for charge saving capacity, cycle reversibility and electrochromic efficiency of film, cyclic voltammetry CV curve can satisfy researchers to evaluate. However, cyclic voltammetry cannot provide a changing mechanism and other related information of films in the electrolyte during the electrochromic process. Then, the quantity of joining charge while changing color process of the electrochromic film can be obtained by integrating CV curves. However, according to the structure of electrochromic electrochemical device, response charge Q of the electrochemical reaction can be divided into Faraday charge quantity (e.g., acting in redox reaction during the electrochromic process), electric double layer charge quantity (e.g., acting in double electric layer exists between electrode and electrolyte), and the charge quantity that is consumed by side reaction in electrolytes. However, literature usually reports that Q obtained from CV is the Q consumed during the electrochromic process. This interpretation of the electrochromic mechanism may be a mistake and may be caused by testing technology limitations. Therefore, it is important to develop testing technology to understand charge reacting situations and reasons of film attenuation the during the electrochromic electrochemical reaction. Thus, there is a need for a method that improves the performance of electrochromic films.

### SUMMARY

The present disclosure related to a method for testing electrochromic film materials using multi-cycle and double potential step chronocoulometry. The method meets researchers' evaluation requirements of cyclic performance of electrochromic materials. The evaluation effect is same as CV method. At the same time, this method provides transmission properties of ion and electron during the electrochromic electrochemical reaction from deep mechanism layer and information of the dynamic change of film during cyclic process. It is convenient to study and modifying for the electrochromic performance of the film.

To realize this target, the present disclosure uses an electrochemical workstation to test electrochromic film through multi-cycle and double potential step chronocoulometry to obtain Q-t curve.

A cyclic stability testing method of electrochromic materials based on multi-cycle and double potential step chronocoulometry is provided. The method may include testing the electrochromic film through multi-cycle and double potential step technology, the extracted charge quantity Qₑₓ, and the injected charge quantity Qᵢₙ of the different cyclic period are calculated or measured respectively, and reversibility R of the film cyclic is obtained by Qₑₓ/Qᵢₙ directly, R=Qₑₓ/Qᵢₙ. Researchers' evaluation requirements of cyclic performance of electrochromic materials are satisfied. Film reversibility is judged directly without CV redox peak.

A cyclic stability testing method of electrochromic materials based on multi-cycle and double potential step chronocoulometry may include testing the electrochromic film through multi-cycle and double potential step technology. Q represents overall response charge of coloring or fading time during a single period, which is divided into 3 parts. These three parts include Faraday charge quantity Q_{f}, adsorption charge quantity Q_{ads} and electric double layer charge quantity Q_{dl}. The influencing factor of ion, electron transmission characteristic and film cyclic stability can be judged through comparing the changing status of Q_{f} and Q_{dl}+nFAΓ under multi-cyclic condition. It is convenient to study and modifying for the electrochromic performance of the film.

To study the cyclic performance of electrochromic film further, electrochromic film electrochemical reaction is analyzed below. When the electrochemical reaction of the film is in progress, Q (e.g., response Q in multi-cycle and double potential step) consumed by this process is from three following parts.

The first part, reversible redox reaction of electrochromic materials is proceeded forced by an electric field, different structure and valence are present before and after reactions. It has different light absorption, and reflection effects, different color of electrochromic materials is shown before and after electric filed action macroscopically, and electric charge consumed in this part is defined as Faraday charge quantity, which is represented by Q_{f}.

The second part, contact of each two different phases generates an electric potential between phases, and excess electrical charge and charge separation are generated between working electrode and electrolyte under electricity, which forms an electric double layer. The charging and discharging phenomena of electric double-layer capacitor EDLC appears under electric field action, and electric charge quantity that joins in charging and discharging process forms one part of the response charge. The electric charge consumed in this part is defined as electric double layer charge quantity and represented by Q_{dl}.

The third part, when electrode voltage or current is higher than the electrolysis voltage or current of active materials in electrolyte, electrolyte active materials that are adsorbed on the surface of the electrochromic film is electrolyzed, and some electric charge is consumed. Since this part of the reaction happens on active materials that are adsorbed on electrochromic film working electrode, this part of charge quantity is represented as Q_{ads}.

Response Q in whole Q-t curve includes 3 parts:

Q=Q_{f}+Q_{ads}+Q_{dl} (1)

According to the basic principle of chronocoulometry,

Q_{ads}=nFAΓ (2)

Q_{f}=2nFAC(D/π)^{1/2}t^{1/2} (3)

n represents charge number that joins in electrochemistry process, F represents Faraday constant, A represents effective area of electrochromic working electrode, Γ represents the quantity of electrolyte active materials adsorbed on surface of working electrode, C represents the concentration of electrolyte, D represents the diffusion coefficient of active materials, and t represents response time.

Q is obtained by a detecting device, Q_{f}=Q−Q_{ads}−Q_{dl}.

Comparing equation (1) (2) (3) and plot Q-t^{1/2}, a line is obtained, the slope is k=2nFAC(D/π)^{1/2} and Q_{ads}+Q_{dl} is the intercept. Thus, Q_{f} can be obtained through the mathematical process, and value of Q_{dl}+nFAΓ can be obtained through intercept. As for a specific electrochromic material and electrochemistry reaction system, Q_{f} is in proportion to A. If the attenuation of Q_{f} is higher than 60% in 10 cyclic periods while at the same time the attenuation of Q_{dl}+nFAΓ is higher than 60%, the binding force is defined as being weak such that detachment of the electrochromic film and a substrate occurs.

If the attenuation percentage of the real value of Q_{dl}+nFAΓ in the same period is higher than Q_{f}, it is indicated that the ability of ion transfer and active material adsorption forced by instability film structure is decreased. This is mainly because of the decreasing of film hole and its broken structure. It needs modified process from the material itself rather than from electroconductibility of film and substance.

Advantages of the present disclosure are provided below. The film changing during the process is analyzed directly, and basic reason of the good or bad performance of cyclic can be obtained, which is suitable for a better actual application. There are two factors that influence electrode effective area A. 1. Surface topography of film and density of film structure, porous, rough surface, and loosened structure are benefited for electrolyte touching with electrode directly. It is better for ion transfer during electrochemical reaction, and electrode effective area A is bigger. 2. Interface contact resistance is between electrode substance and electrochromic film, and the better film electroconductibility, the better associativity between substance and film is. Also, it is good for ion transfer so that the film effective area is bigger.

### BRIEF DESCRIPTION OF THE DRAWINGS

FIG. 1 is a structure diagram of electrochemical reaction device for preparation of electrochromic film in the present disclosure using NiO electrochromic film as an example.

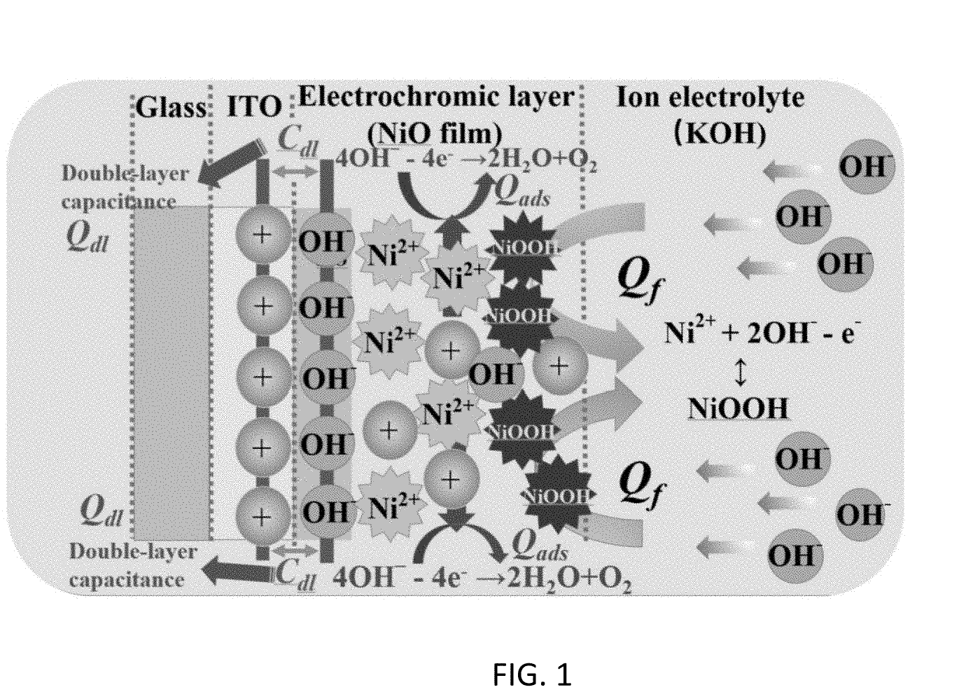

FIG. 2 is a Q-t curve diagram of NiO chronocoulometry.

FIG. 3 is R chart obtained from NiO chronocoulometry.

FIG. 4 is a cycle number diagram of Q_{f} and (Q_{dl}+nFAΓ)-obtained from NiO chronocoulometry.

### DETAILED DESCRIPTION OF THE PREFERRED EMBODIMENTS

The present disclosure is described in more detail accompanied with the appended drawings. The present disclosure is not limited to this only embodiment disclosed below.

1). The electrochromic film is prepared and then electrochromic electrochemical reaction system is built up with electrolyte, a reference electrode, and the platinum-plate counter electrode.

2). The electrochemical workstation is used to operate double potential step chronocoulometry for a multi-cyclic test of the film, and all Q-t data is recorded from initial stage to total attenuation stage during the multi-cyclic process of the electrochromic film.

3). Qₑₓ and Qᵢₙ in Q-t data are analyzed to obtain the film cyclic reversibility R, R=Qₑₓ/Qᵢₙ.

4). Q-t curve is selected with an appropriate cyclic interval, a mathematical transformation is made to get a line Q-t^{1/2}, under the corresponding cyclic number, and the slope and intercept in Q axis of Q-t^{1/2} are calculated. Slope corresponds to Q_{f} and intercept corresponds to Q_{dl}+nFAΓ.

5). Q_{f} and Q_{dl}+nFAΓ is processed in corresponding cyclic number to get Q_{f} cyclic number-(Q_{dl}+nFAΓ) cyclic number to get cyclic number diagram.

6). The variation tendency, variation order and variation rate of Q_{f} cyclic number-(Q_{dl}+nFAΓ) cyclic number diagram are compared. Changing mechanism of the film is analyzed to obtain basic reason whether the cyclic performance is good or not.

### Embodiment 1

1) NiO electrochromic film is prepared on ITO conductive glass substrate through sol-gel method; then the electrochromic electrochemical reaction system is built up with electrolyte KOH, reference electrode Ag/AgCl and platinum-plate electrode as the counter electrode.

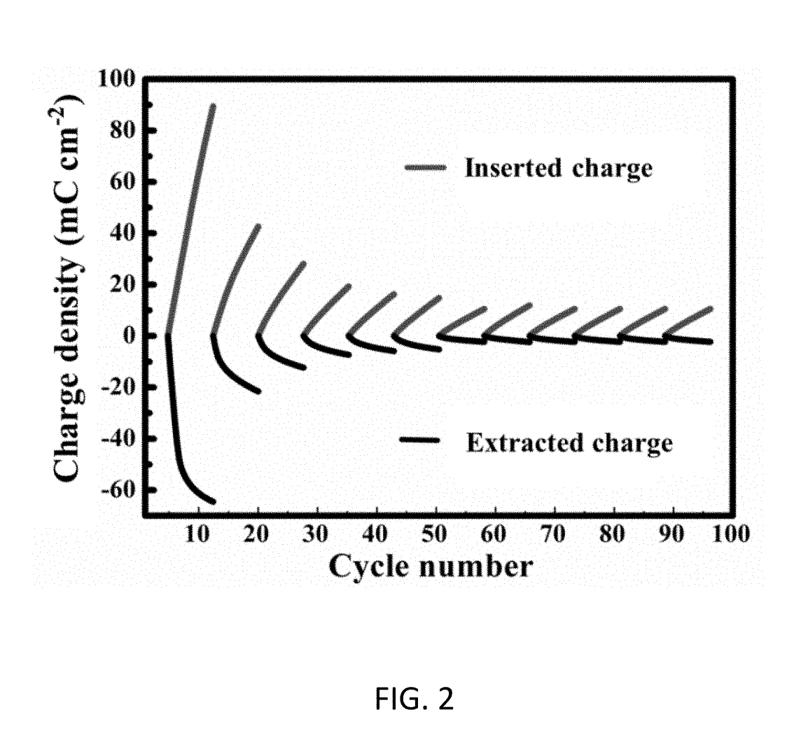

2) The electrochemical workstation is used to operate double potential step chronocoulometry for a multi-cyclic test of the film. As shown In FIG. 2, 1500 Q-t data are recorded from initial stage to total attenuation stage during the multi-cyclic process of NiO electrochromic film.

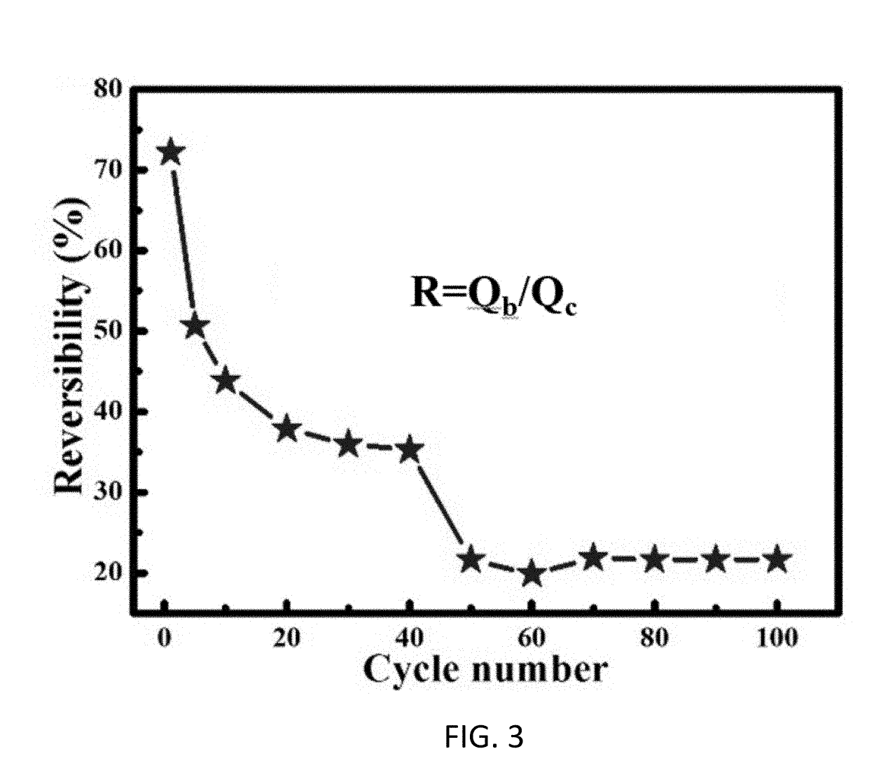

3) Q_{b} and Q_{c} in Q-t data are analyzed to obtain the film cyclic reversibility R, and R=Qₑₓ/Qᵢₙ, as is shown in FIG. 3. It can be indicated that the R of the film decreases continuously with cyclic so that this film has bad cyclic performance.

4) Q-t curve is selected with every 1000 cyclic interval, and mathematical transformation is made to get a line Q-t^{1/2}. Under corresponding cyclic number, the slope and intercept in Q axis of Q-t^{1/2} are calculated. The slope corresponds to Q_{f} and intercept corresponds to Q_{dl}+nFAΓ.

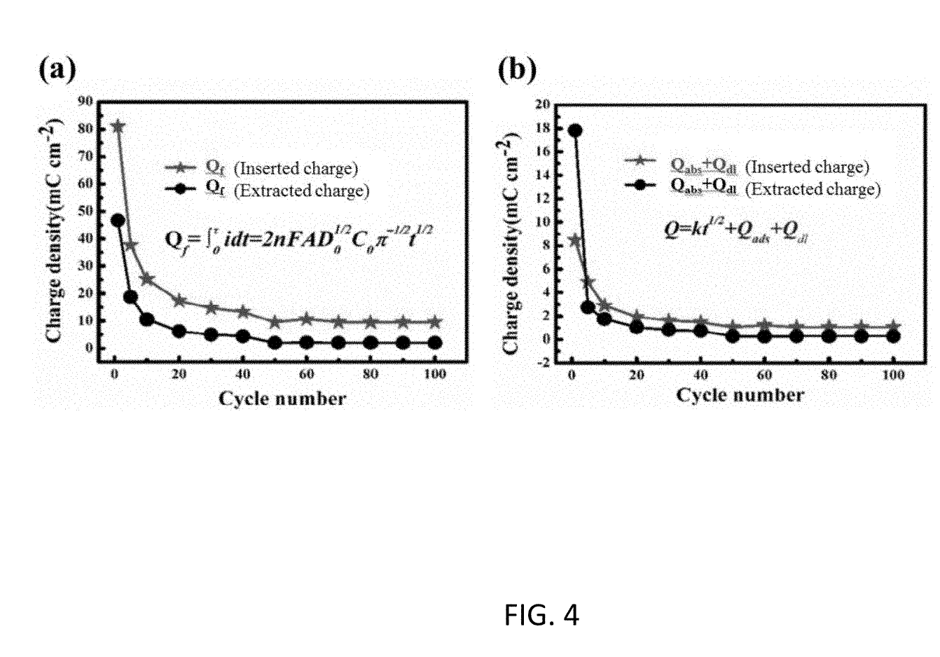

5) Q_{f} and Q_{dl}+nFAΓ are processed in corresponding cyclic number to get Q_{f} cyclic number-(Q_{dl}+nFAΓ) cyclic number to get cyclic number diagram, as is shown in FIG. 4.

The variation tendency, variation order and variation rate of Q_{f} cyclic number-(Q_{dl}+nFAΓ) cyclic number diagram are compared. It was found that Q_{f} and Q_{dl}+nFAΓ is attenuating fast In 10^{th} with increasing of cyclic times based on equation (2) and (3). It means the film effective area A is decreasing fast during short cyclic times. Instantaneously detachment happened in the juncture between substrate and film leads to the fast efficiency loss of film. In an experiment, it was observed that film detached at 10^{th} circulation. Combined extent between substrates and films needs to adjust through advanced technology to increase film life. As is shown in FIG. 4, the detachment occurred.

1. A method for testing and analysis of cyclic stability of electrochromic materials using multi-cycle and double potential step chronocoulometry, the method comprising:
testing an electrochromic film using the multi-cycle and double potential step chronocoulometry to calculate or measure extracted charge quantity Qₑₓ and injected charge quantity Qᵢₙ of different cyclic periods, respectively, reversibility, and to obtain R using equation R=Qₑₓ/Qᵢₙ, wherein the testing the electrochromic film using the multi-cycle and double potential step chronocoulometry comprises:
dividing Q representing overall response charges of coloring or fading time during a single period into three parts including Faraday charge quantity Q_{f}, adsorption charge quantity Q_{ads}, and electric double layer charge quantity Q_{dl}; and
determining factors that affect transmission characteristics of ions and electrons in a reaction system and film cyclic stability by comparing changes of Q_{f} and Q_{dl}+nFAΓ under multi-cyclic conditions, wherein:
in the first part of three parts, reversible redox reactions of electrochromic materials are proceeded forced by electric fields, the reversible redox reactions have different structures and valences before and after the reactions and have different light absorption and reflection effects such that different colors of electrochromic materials are shown before and after electric field effects macroscopically, and electric charges consumed in this part are defined as Faraday charge quantity and represented by Q_{f},
in the second part of three parts, interactions of each two different phases generate electric potential between phases, extra electrical charges and charge separations are generated between working electrodes and electrolytes under electricity forming an electric double layer, charging and discharging phenomena of electric double-layer capacitor EDLC are present under the electric field effects, electric charge quantity that joins in charging and discharging process forms one part of the response charges, and Q_{dl} is defined as electric double layer charge quantity, and
in the third part of the three parts, when electrode voltages or currents are higher than the electrolysis voltages or currents of active materials in electrolyte, electrolyte active materials adsorbed on the surface of the electrochromic film are electrolyzed, electric charges are consumed, and the reaction occurs in the active materials adsorbed on the electrochromic film of the working electrode represented by Q_{ads}.

2. (canceled)

3. The method of claim 1, wherein the Q in whole Q-t curve includes 3 parts:
Q=Q_{f}+Q_{ads}+Q_{dl} (1),
according to the basic principle of chronocoulometry,
Q_{ads}=nFAΓ (2),
Q_{f}=2nFAC(D/π)^{1/2}t^{1/2} (3), and wherein:
n represents a charge number that joins in the electrochemistry process, F represents Faraday constant, A represents an effective area of the electrochromic working electrode, Γ represents the quantity of electrolyte active materials adsorbed on surface of working electrode, C represents the concentration of electrolyte, D represents the diffusion coefficient of active materials, and t represents response time;
Q is obtained by a detecting device, Q_{f}=Q−Q_{ads}−Q_{dl};
equation (1) (2) (3) and plot Q-t^{1/2} are compared to obtain a line slope represented by k=2nFAC(D/π)^{1/2} and Q_{ads}+Q_{dl} is the intercept; Q_{f} is obtained through the mathematical process, a value of Q_{dl}+nFAΓ is obtained through intercept; as for a specific electrochromic material and electrochemistry reaction system, Q_{f} is in proportion to A; if the attenuation of Q_{f} is higher than 60% in 10 cyclic periods while at the same time the attenuation of Q_{dl}+nFAΓ is higher than 60%, the binding force is defined as being weak such that detachment of the electrochromic film and a substrate occurs.
